(19) United States
(12) Patent Application Publication
(10) Pub. No.: US 2020/0048065 A1
(43) Pub. Date: Feb. 13, 2020

(54) System and Methods for Automatic Container Filling

(71) Applicant: The Recon Group LLP, Miami, FL (US)

(72) Inventor: Sender Shamiss, Miami, FL (US)

(73) Assignee: The Recon Group LLP, Miami, FL (US)

(21) Appl. No.: 16/058,461

(22) Filed: Aug. 8, 2018

(51) Int. Cl. B67C 3/28; B65B 57/06; B65B 1/06

(52) U.S. Cl. CPC B67C 3/282; B65B 1/06; B65B 57/06

(57) ABSTRACT

The present disclosure provides an improved system and related methods for automatic container filling. Combining the use of proximity sensors for real-time monitoring of container fill level and an electromechanical apparatus for regulating the position of a reversibly-extensible member of a conveying chute enables control over key aspects of article delivery to the container, the container filling process, the odds of article breakage during filling and the non-uniformity of mass distribution. Changing the position of the reversibly-extensible member changes the length of the chute bed, the freefall trajectory of articles diverted in the chute to the container, and impulse of the articles as they strike a surface of a heap of articles in the container.

### FIELD OF THE INVENTION

The present disclosure relates to article sortation, and more particularly to a system and method for container filling processes involving a chute.

### BACKGROUND OF THE INVENTION

Different kinds of diversion chute are known in the art, for example, a gradient or gravity conveying chute. Use of a diversion chute to fill a container, though advantageous for many applications, can have various undesirable outcomes. If, for example, the closest wall of a container to the end of the diversion chute is not sufficiently close to the chute, materials or articles intended for deposit could fall outside rather than inside the container. Another possible undesirable outcome is the breakage of materials or articles during, or in relation to, container filling.

The volume of a container can greatly exceed the volume of an article deposited therein. The likelihood of article breakage on container filling will be high in certain instances, for example, depositing a small and fragile article in a large container from a height comparable to the height of the container. The article will be in gravitational freefall from the moment no normal force is exerted, for example, when the article leaves the lower end of a gradient chute and falls through the air until the article strikes an upper surface of a heap of articles in the container (air resistance will generally be negligible). The longer an article is in freefall, the greater the speed and therefore the impulse on striking the heap of articles.

Article breakage risk will be even higher, in general terms, if a large container is filled with generally small articles of arbitrary size, shape and orientation in an automated process that ignores the extent of container filling throughout the filling process. This can lead to an unstable weight distribution, quite apart from overflow, and a shifting of contained articles in transport. Container filling with articles of arbitrary size, shape and orientation will generally result in a low packing density, increasing the odds of article breakage during container filling or transport.

Filling a container with irregular and possibly different-sized articles can also significantly increase the odds of a substantial non-uniform distribution of mass in a container. Irregular mass distribution will be especially likely if the articles are deposited from a single location or limited range of locations, for example, the end of a gravity conveying chute that has a fixed orientation with respect to the container. Non-uniform article mass distribution is potentially problematic for the structural integrity of the container before and during transport.

Indiscriminate filling of a container with different-sized and irregularly-shaped articles can also be an ineffective use of space, increasing the cost of transporting the contained goods by increasing the number of bins needed to contain them.

There are, then, several possible reasons to monitor various aspects of a container filling process. For such reasons and others, it is desirable to develop systems and methods for improving container filling processes involving chutes. Despite advances in this area, further improvements are possible.

### SUMMARY OF THE INVENTION

In view of the foregoing, it is an object of the present disclosure to provide an improved system and related methods of automatic filling of a container with articles of arbitrary size, shape and orientation. In an aspect of the present invention, the system comprises a chute, an extensible member and one or more proximity sensors. The chute is configured for having an entrance end through which an article enters the chute, a chute bed for conveying the article, and an exit end through which the article exits the chute. The extensible member is configured for being mechanically coupled to the chute and moving between a retracted position and at least one extended position. The one or more proximity sensors are configured for detecting the presence and fill level of the container. The at least one extended position of the extensible member does increase the length of the chute bed and the retracted position of the extensible member does not increase the length of the chute bed, and the extensible member adopts a position in response to the fill level detected by the one or more proximity sensors.

In an embodiment of the present invention, a chain, a sprocket, a motor, a motor shaft, and an extensible member are used to vary the length of a variable-length chute. A signal is sent to the motor, causing it to rotate accordingly. Rotating the motor rotates the shaft, which is mechanically coupled to the motor. Rotating the shaft rotates the sprocket, which is mechanically coupled to the shaft. Rotating the sprocket moves the chain, which is mechanically coupled to the sprocket. Moving the chain moves the extensible member of the chute, which is mechanically coupled to the chain.

In another embodiment of the present invention, a container is filled with articles from a chute with an attached extensible member configured for extending chute length, one or more proximity sensors detect a container fill level, and one or more proximity sensors detect the extensible member position. If the detected fill level is below a first predetermined amount, there are four possible actions. One, if the fill level is below a second predetermined amount and the extensible member is in a retracted position, move the extensible member to an extended position and the allow transfer of articles to the chute. Two, if the fill level is below a second predetermined amount and the extensible member is in an extended position, maintain the extensible member in the extended position and allow the transfer of articles to the chute. Three, if the fill level is above a second predetermined amount and the extensible member is in an extended position, move the extensible member to a retracted position and allow the transfer of articles to the chute. Four, if the fill level is above a second predetermined amount and the extensible member is in a retracted position, maintain the extensible member in the retracted position and allow the transfer of articles to the chute. If, by contrast, the fill level is above a first predetermined amount, there is one possible action: disallow the transfer of articles to the chute.

These and other objects, aspects and advantages of the present invention will be better appreciated in view of the drawings and following detailed description of preferred embodiments.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a schematic depiction of a representative embodiment of the present chute extension system A) early and B) late in a container filling process.

FIG. 2 is a first schematic depiction of an embodiment of an electromechanical assembly of the present invention;

FIG. 3 is a second schematic depiction of an embodiment of an electromechanical assembly of the present invention;

FIG. 4 is a schematic depiction of a representative configuration of the system for monitoring container filling;

FIG. 5 is a flowchart of an example method of using an electromechanical assembly to achieve reversible extension and retraction of a reversibly-extensible member of a variable-length chute;

FIG. 6A-C is a flowchart of an example method of using proximity sensors to monitor the filling of a container and to control the position of a reversibly-extensible member of a variable-length chute.

### DETAILED DESCRIPTION OF PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

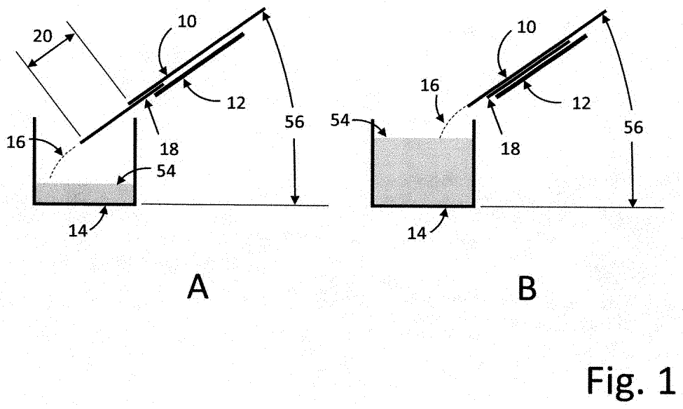

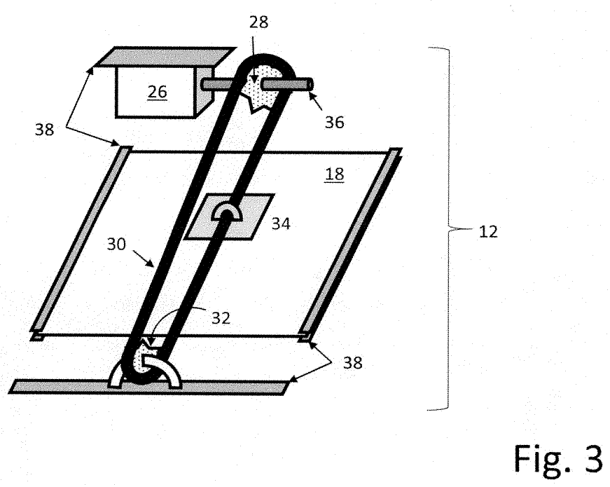

Referring to FIGS. 1-3, the present invention comprises a conveyor chute 10, a reversibly-extensible member 18 coupled to the conveyor chute 10 (by a means discussed below) and an electromechanical assembly 12 coupled to the reversibly-extensible member 18 and to the chute 10 (FIG. 3). A main purpose of the electromechanical assembly 12 is to adjust the position of the reversibly-extensible member 18 and thus adjust the length of the conveyor chute 10 (FIG. 1). Control over chute length differs from control over article transfer to the chute.

In an embodiment of the present invention, a reversibly-extensible member 18 has approximately the same contour as the bed of a conveyor chute 10 (FIG. 1). An article (not shown for clarity) to be diverted via the conveyor chute 10 to a container 14 can traverse the conveyor chute 10 under the force of gravity and, having reached the lower end of the conveyor chute 10, fall into the container 14. The container 14 can be in some embodiments a gaylord, a corrugated pallet box. In another embodiment of the present invention, an article can enter a conveyor chute 10 from an article handling machine (not shown), for example, a sortation conveyor. In yet another embodiment of the present invention, the height of the sides of a container 14 can be comparable to the height of the lower end of a conveyor chute 10 when the container 14 is suitably positioned for receiving articles from the conveyor chute 10, as in FIG. 1.

Extension or retraction of a reversibly-extensible member 18 can alter the effective length of a conveyor chute 10. The range of extension can be, in an embodiment of the present invention, from the original length of the conveyor chute 10 (no extension of the reversibly-extensible member 18, FIG. 1A) to the original length plus a length 20 (full extension of the reversibly-extensible member 18, FIG. 1B). Adjusting the effective length of the conveyor chute 10 can alter the difference in height between the end of the conveyor chute 10 and an upper surface 54 of a heap of articles in a container 14 and thus the freefall trajectory 16 of an article and its impact on striking the upper surface 54 of the heap of articles; it being assumed that the container 14 is suitably positioned to receive the article, as in FIG. 1.

In an embodiment of the present invention, a reversibly-extensible member 18 can be extended or retracted to ensure the absence of a horizontal or vertical gap between the end of a chute 10 and the top of the nearest wall of a container 14 (FIG. 1). In another embodiment, a reversibly-extensible member 18 can be extended or retracted to limit the impulse on the article on striking an upper surface 54 of a heap of articles deposited in a container 14 (FIG. 1). In yet another embodiment, a reversibly-extensible member 18 can be extended or retracted to increase the uniformity of mass distribution in a container 14, determining, for example, whether articles are deposited closer to the farthest wall or the nearest wall of the container 14 relative to the end of a chute 10 (FIG. 1). In still another embodiment, a reversibly-extensible member 18 can be extended or retracted to increase the effectiveness of space utilization by articles deposited in a container 14.

In an embodiment of the present invention, a conveyor chute 10 is a flatbed chute, that is, a chute with a flat conveying surface, as in FIG. 1. In this case a reversibly-extensible member 18 used to adjust the effective length of the chute 10 can be a flat plate of comparable rigidity and surface properties to the bed of the chute 10, and the reversibly-extensible member 18 can be extended outward from, or retracted inward to, the underside of the conveyor chute 10, roughly parallel to the conveyor chute 10 and therefore at an angle 56, the angle between the plane of the bed of the conveyor chute 10 and the horizon (see FIG. 1).

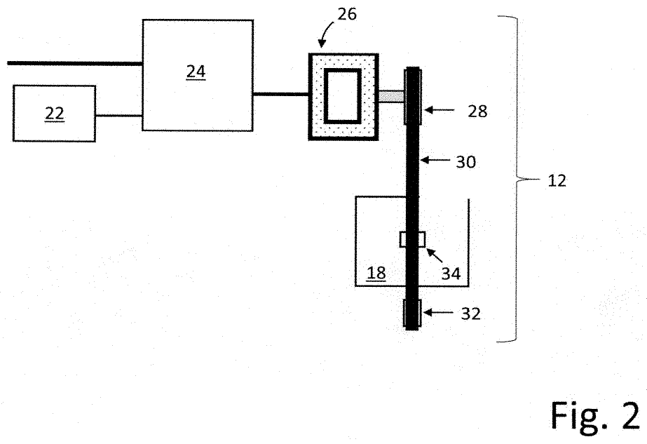

Referring more specifically to FIGS. 2 and 3, an embodiment of the electromechanical assembly 12 of the present invention comprises a drive interface 22, a drive controller assembly 24 electrically coupled to the drive interface 22, and a motor 26 electrically coupled to the drive controller assembly 24. In one embodiment, the electromechanical assembly 12 further comprises a first sprocket 28, a chain 30, a second sprocket 32, and a chain fixture 34. A reversibly-extensible member 18 can be mechanically coupled to the chain 30 by the chain fixture 34, and the chain 30 can be coupled to the first and second sprockets 28 and 32. In an embodiment of the present invention, a first sprocket 28 can be further mechanically coupled to a motor shaft 36, which can be mechanically coupled to a motor 26. In an embodiment a motor 26 and a second sprocket 32 can be separately mechanically coupled to a conveyor chute 10 or a frame 38 that supports the conveyor chute 10. The motor 26 can thus be used to effect an extension or retraction of a reversibly-extensible member 18 relative to a conveyor chute 10, the direction of motion depending on the sense of rotation of a motor shaft 36. Actuation of the motor shaft 36 and its direction of rotation can be determined by electrical signals sent to the motor 26 by a drive controller assembly 24.

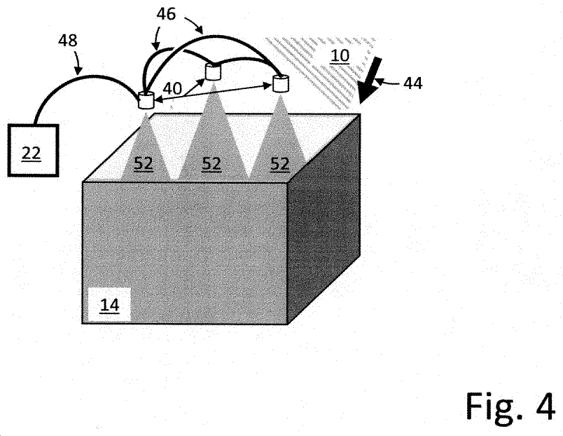

In an embodiment of the present invention, a drive controller assembly 24 can be encompassed by a variable-frequency drive (VFD). The main drive controller assembly of the VFD can be the drive controller assembly 24, which can be in electrical communication with a drive interface 22 (FIG. 2). The drive interface 22 can conform to the RS-485 differential signaling standard or a similar standard and thus be used to communicate with one or more proximity sensors 40 (e.g. by electrical connections 48, see FIG. 4), one or more other proximity sensors (e.g. sensors to monitor the position of a reversibly-extensible member 18), and one or more systems (e.g. an article handling machine, not shown) or components thereof (e.g. a diverter swing arm, not shown) for regulating the flow of articles to a chute 10 used to convey articles to a container 14.

In an embodiment of the present invention, a reversibly-extensible member 18 can have at least two normal positions: “fully retracted” and “fully extended” relative to the end of a conveyor chute 10. Representative illustrations are provided in panels A and B of FIG. 1. The reversibly-extensible member 18 can be fully retracted when no container 14 is present. When a container 14 is present, the reversibly-extensible member 18 can be fully extended by a length 20 in an automatic or a manual process. A condition of the reversibly-extensible member 18 staying fully extended can be a container 14 in place and less than half full. When the container 14 becomes more than half full, an electromechanical assembly 12 can be used to retract the reversibly-extensible member 18 to the same position as when no container 14 is present.

In an embodiment of the present invention, whether a container 14 is below (FIG. 1A) or above (FIG. 1B) half full can be determined by signals received from one or more proximity sensors 40 (see FIG. 4). The one or more proximity sensors 40 can be used to detect the distance from each of the proximity sensors 40 to the corresponding regions within detection cone 52 on an upper surface 54 of a heap of articles in the container 14. In such an arrangement, the present invention can achieve several purposes at once: reduce the likelihood of physical damage to an article of arbitrary size, shape and orientation when it is deposited in the container 14 from the conveyor chute 10, increase the likelihood of even filling of the container 14 with articles of arbitrary size and shape, and increase the effectiveness of space utilization in the container 14 when it is filled with articles of arbitrary size, size and orientation.

In an embodiment of the present invention, a reversibly-extensible member 18 can be configured for movement between pre-determined positions. The position of the reversibly-extensible member 18 (FIG. 1) can depend on electrical signals sent by a drive controller assembly 24 (FIG. 2), which can in turn depend on electrical signals sent by a drive interface 22 (FIG. 2), which can in turn depend on electrical signals sent by one or more proximity sensors 40 (see FIG. 4) used to monitor the filling of a container 14 and by one or more proximity sensors (not shown) used to monitor the position of the reversibly-extensible member 18 relative to a frame 38 of the chute 10 (FIG. 3).

One or more proximity sensors can be used to monitor the position of a reversibly-extensible member 18. These one or more proximity sensors for can be positioned in various convenient locations, for example, key locations underneath the chute 10. In an embodiment of the present invention, these one or more proximity sensors collectively can display several states, reflecting different possible states of the reversibly-extensible member 18. In one embodiment of the present invention there are five states of reversibly-extensible member 18 and of the one or more proximity sensors used to monitor its position: 1) “high normal” (no container 14 is present, or a container 14 is present and more than half full, as in FIG. 1B; a first sensor activated); 2) “low normal” (a container 14 is present and less than half full, as in FIG. 1A; a second sensor activated); 3) “high abnormal” (the reversibly-extensible member 18 is over-retracted; a third sensor activated); 4) “low abnormal” (the reversibly-extensible member 18 is over-extended; a fourth sensor activated); and 5) “in motion” between the “high normal” and “low normal” states (the reversibly-extensible member 18 is neither fully extended nor fully retracted; no sensor activated). The one or more proximity sensors used to monitor the position of the reversibly-extensible member 18 can be, like the one or more proximity sensors 40, in electrical communication with a drive interface 22. The use of sensors to detect over-extension or -retraction of the reversibly-extensible member 18 can help avoid damaging motor-coupling parts of the present containing-filling system, for example, a chain fixture 34 (FIG. 3).

In an embodiment of the present invention a reversibly-extensible member 18 can be maintained in close proximity to the bed of a conveyor chute 10 by a frame 38 of the conveyor chute 10, as in FIG. 3. The frame 38 can be mechanically coupled to the conveyor chute 10 and designed as a track for rollers (not shown) mechanically coupled to the corresponding edges of the reversibly-extensible member 18. The rollers can be used to control static and kinetic friction between the reversibly-extensible member 18 and the frame 38.

Referring to FIG. 4, a system for automatic container filling comprises one or more proximity sensors 40 configured for monitoring the filling of a container 14, a conveyor chute 10 configured for filling the container 14, electrical connections 46 configured for electrical signal communication between the one or more proximity sensors 40, and electrical connections 48 configured for electrical signal communication between the one or more proximity sensors 40 and a drive interface 22. Each proximity sensor will have a sensing cone 52. The drive interface 22 can be in electrical communication with a motor (e.g. motor 26 in FIGS. 2 and 3), which can be used to adjust the position of a reversibly-extensible member 18 of the chute 10 in relation to the presence or absence of a container 14 or the extent of filling of the container 14.

In an embodiment of the present invention, a conveyor chute 10 is oriented at an angle 56 relative to horizon so that the lower end of the conveyor chute 10 will be at approximately the same height as the wall of a container 14 and the upper end of the conveyor chute 10 will be at a greater height (see FIG. 1). The conveyor chute 10 thus configured can be used to convey an article (not shown) in the direction of arrow 44, from the top to the bottom of the conveyor chute 10 into a container 14, under the force of gravitational attraction of the article to Earth. One or more proximity sensors 40 can be positioned above the container 14 such that the sensing cones 52 of the one or more proximity sensors 40 can be used to monitor changes in the distance between the one or more proximity sensors 40 and an upper surface 54 of a heap of articles (hidden from view in FIG. 4 but shown in FIG. 1) in the container 14.

In an embodiment of the present invention, a drive interface 22 is in electrical communication with a drive controller assembly 24, which is used to drive a motor 26 (FIG. 2), and the motor 26 can be used to change the effective length of the chute 10 by changing the position of a reversibly-extensible member 18 (FIG. 3) in response to electrical signals received from one or more proximity sensors 40 (FIG. 4) in relation to the extent of filling the container 14 (FIG. 1). For example, there can be two normal positions of the reversibly-extensible member 18: “fully retracted” and “fully extended.” The reversibly-extensible member 18 can be fully retracted when electrical signals sent from the one or more proximity sensors 40 to the drive interface 22 indicate that no container 14 is present. When electrical signals sent from the one or more proximity sensors 40 to the drive interface 22 indicate that a container 14 is present and less than half full, the drive interface 22 can signal the drive controller assembly 24 to drive the motor 26 and thus to move the reversibly-extensible member 18 (FIG. 3) to a fully extended position (FIG. 1A). When electrical signals from the one or more proximity sensors 40 indicate that a container 14 is present and more than half full, the drive interface 22 can signal the drive controller assembly 24 to drive the motor 26 and thus to move the reversibly-extensible member 18 (FIG. 3) to a fully retracted position (FIG. 1B).

In an embodiment of the present invention, one or more proximity sensors 40 are located above a container 14, as shown in FIG. 4. The one or more proximity sensors 40 are configured to sense the fill level in different regions of the container 14, for example, in each of the four corners of a cubical or approximately cubical container, for example, a gaylord. Each proximity sensor 40 can be used to provide, within its respective sensing cone 52, independent real-time sensing of the distance from the proximity sensor 40 to the upper surface 54 of a heap of articles deposited within the container 14. The electrical signal of each proximity sensor 40 can be sent to a drive interface 22, which can be coupled to a drive controller assembly 24 and a motor 26 (FIG. 2) used to adjust the position of a reversibly-extensible member 18 in relation to the extent of filling of container 14.

In an embodiment of the present invention, at least one of the one or more proximity sensors 40 can be an ultrasononic sensor. Such sensors can emit acoustic pulses, detect reflections of the emitted pulses, measure the time elapsed between sending and receiving pulses, and calculate the corresponding distance based on the speed of sound in air.

Each of the one or more proximity sensors 40 can be configured to send an electrical signal to a drive interface 22. The drive interface 22 can be a RS-485 interface. The electrical signal can encode the distance from the respective proximity sensor 40 to an upper surface 54 of a heap of articles in a container 14 within the respective sensing cone 52 of the proximity sensor 40. In an embodiment of the present invention, each of the one or more proximity sensors 40 can have an RS-485 communications interface. All of the one or more proximity sensors 40 can thus communicate over a single network that can be monitored by a single drive interface 22.

A drive interface 22 can respond to signals received from one or more proximity sensors 40. If one or more of the detected distances between the one or more proximity sensors 40 and an upper surface 54 of a heap of articles in a container 14 within the respective sensing cones 52 is initially greater than a certain threshold distance but becomes less than this distance in the course of a filling process, the drive interface 22 can send an electronic signal to a drive controller assembly 24 of a motor (not shown), causing a change in one or more determinants of a container filling process. One such determinant can be, for example, the rate at which articles are conveyed to the container 14 or the length of a chute 10 used to convey articles to the container 14. The one or more proximity sensors 40 can thus be used to limit physical damage to articles in a container filling process and increase the uniformity of the distribution of mass in the container 14.

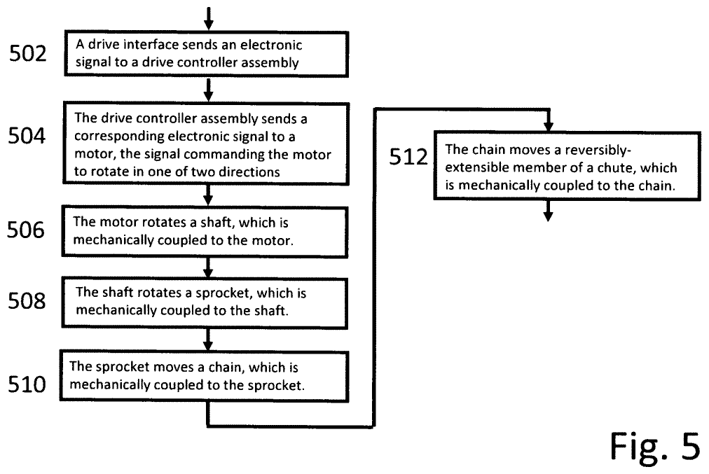

Referring to FIG. 5, the present method of adjusting the length of a reversibly-extensible member of a variable-length chute includes, at step 502, a drive interface sending an electronic signal to a drive controller assembly.

In step 504, the drive controller assembly sends a related electronic signal to a motor, commanding the motor to rotate in one of two directions.

In step 506, the motor rotates a shaft, which is mechanically coupled to the motor.

In step 508, the shaft rotates a sprocket, which is mechanically coupled to the shaft.

In step 510, the sprocket moves a chain, which is mechanically coupled to the sprocket.

In step 512, the chain moves a reversibly extensible member of a chute, which is mechanically coupled to the chain.

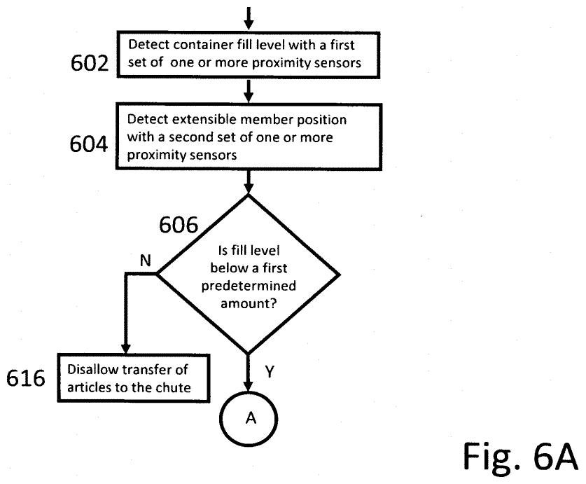

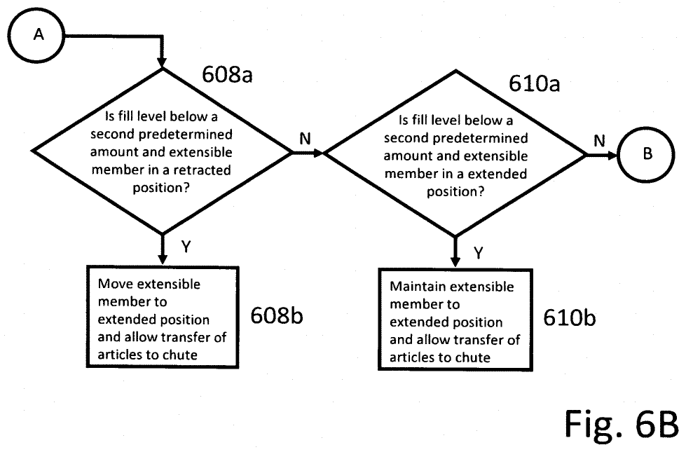

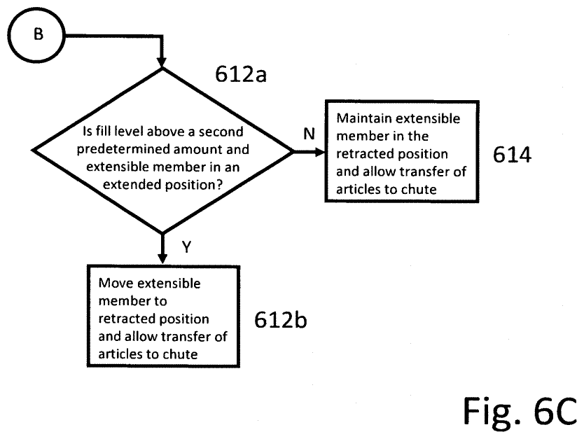

Referring to FIG. 6, a method of filling a container with articles from a chute with an attached extensible member configured for extending chute length involves two sets of one or more proximity sensors. The method comprises, at step 602, detecting a container fill level with a first set of one or more proximity sensors.

At step 604, a second set of one or more proximity sensors, detects a position of the extensible member.

At step 606, if the fill level is below a first predetermined amount, then go to step 608. Otherwise, go to step 616.

At step 608a, if the fill level is below a second predetermined amount and the extensible member is in a retracted position, then at step 608b, move the extensible member to an extended position and allow the transfer of articles to the chute.

At step 610a, if the fill level is below a second predetermined amount and the extensible member is in an extended position, then at step 610b maintain the extensible member in the extended position and allow the transfer of articles to the chute.

At step 612a, if the fill level is above a second predetermined amount and the extensible member is in an extended position, then at step 612b move the extensible member to a retracted position and allow the transfer of articles to the chute.

At step 614 (if the fill level is above a second predetermined amount and the extensible member is in a retracted position), maintain the extensible member in the retracted position and allow the transfer of articles to the chute. Here, the conditional is unnecessary, as it is the only follow-on possibility if the condition in step 606 is satisfied.

At step 616 (if the fill level is above a first predetermined amount), disallow the transfer of articles to the chute. Again, the conditional is superfluous, as it has already been applied in step 606; the condition in step 606 is not satisfied.

The present invention can be used to decrease the likelihood of article breakage on being deposited in a container, increase the uniformity of the distribution of mass in a container, and increase the effectiveness of space utilization in a container in relation to an automatic container filling process. The present invention can also be used to improve automated container filling by making use of real-time monitoring of fill level. Electronic signaling related to fill level and the adjustment of aspects of the filling process can be used to limit the breakage of articles of arbitrary shape and size used to fill the container. The method will be especially useful if the articles are non-uniform in shape, size and orientation.

As used herein, ‘arbitrary shape and size’ means “any size or shape small enough to fit into a container.”

‘Article’ means “an object, for example, a unit of merchandise.”

‘Container’ means “a collection receptacle that is, in general, much larger than an individual article used to fill it.

‘Conveyor chute’ means “a sloping channel, slide, shaft, funnel or conduit for conveying articles away from a location at a higher gravitational potential, for example, the location of a diverter arm on a conveyor line, to a location at a lower gravitational potential, for example, a container.”

‘Fill level’ of a container means “the extent of filling” the container, “the upper surface of the heap of articles deposited” in the container.

The RS-485 standard defines the electrical characteristics of drivers and receivers used to implement a balanced multipoint transmission line in a serial communications system. Two signal lines are needed. The voltage of one is the inverse of the other, enabling bidirectional communication by a single twisted pair cable over a broad frequency range. The RS-485 driver makes use of three-state logic. This enables the selective deactivation of individual transmitters in the communications system and makes the driver useful for industrial control applications. The individual transmitters can be sensors, the sensors can be used to monitor container filling.

‘Ultrasonic sensor’ means “a non-contact sensor that operates by the propagation of sound waves.” The distance to the detected object is determined by a sound transmission time. The range of an ultrasonic sensor in air can be on the order of 1 m, the spatial resolution of the distance measurement can be within a fraction of a centimeter, background signal suppression can be excellent, there can be an analog output signal in real time in the milliampere range, there can be additional switching output, and the output signal can be sent to a drive interface conforming to a standard communications protocol.

Ultrasonic sensors are useful for monitoring the filling of containers with objects of arbitrary size, shape and orientation, because they can measure the distance to or position of materials of different morphology. Sensor utility, moreover, can be independent of the color or surface finish of the materials detected and unimpaired by reflections from transparent objects. Furthermore, ultrasonic sensors are not affected by any dust or dirt that might be present on the materials. Such qualities make ultrasonic sensors reliable devices for level-detection applications, for example, monitoring the distance to material deposited in container to prevent overfilling.

An ultrasonic sensor can have two independent analog outputs. This can enable monitoring of two fill levels, for example, a lower level and an upper level. In this case, a first independent output setting can indicate a minimum fill level, and a second independent output setting can indicate a pre-determined maximum fill level. A single sensor can send a switching signal when the pre-determined maximum fill level is reached, providing concurrent feedback and a voltage or current output.

A switching signal that indicates a pre-determined maximum fill level can be used for a variety of purposes. For example, the switching signal can be used to alter one or more properties of a gradient chute to influence the filling process. The switching signal can also be used to block the chute, disallowing the flow of articles altogether. An alternative is to use the switching signal to adjust some property of the chute, for example, the gradient or the length. A proximity sensor can thus be used to increase the operational efficiency of container filling, for example, the collection of articles of arbitrary size, shape and orientation.

‘Variable frequency drive’ means “a VFD drive system comprising three key elements: an alternating current (AC) motor, a main drive controller assembly and a drive interface.” A VFD allows control over the direction and speed of a motor shaft by control over the amplitude and frequency of the voltage signal sent from the drive controller assembly to the motor. The motor can be a three-phase induction motor coupled to a reducer to increase torque.

Many additional modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within.

The foregoing is provided for illustrative and exemplary purposes; the present invention is not necessarily limited thereto. Rather, those skilled in the art will appreciate that various modifications, as well as adaptations to particular circumstances, are possible within the scope of the invention as herein shown and described.

What is claimed is:

1. A system for automatic filling of a container with articles, the system comprising:
a chute configured for having:
an entrance end through which an article enters the chute;
a chute bed for conveying the article; and
an exit end through which the article exits the chute;
an extensible member configured for being mechanically coupled to the chute and moving between at least a retracted position and an extended position; and
one or more proximity sensors configured for detecting the presence and fill level of the container;
wherein the extended position of the extensible member does increase the length of the chute bed and the retracted position of the extensible member does not increase the length of the chute bed; and
wherein the extensible member adopts a position in response to the fill level detected by the one or more proximity sensors.

2. The system of claim 1, wherein the system further comprises a first electromechanical assembly configured to manipulate the extensible member, moving it between the retracted position and the extended position of the extensible member.

3. The system of claim 2, wherein the electromechanical assembly further comprises a chain, a first sprocket, a second sprocket, a motor, and a motor shaft:
the chain being configured for turning the first sprocket and the second sprocket;
the first sprocket being configured for mechanical coupling to the motor shaft;
the second sprocket being configured for mechanical coupling to the chute;
the motor shaft being configured for mechanical coupling to the motor;
the motor being configured for mechanical coupling to the chute; and
the chain being configured for mechanical coupling to the extensible member.

4. The system of claim 1, wherein the system further comprises a plurality of proximity sensors configured to detect the position of the extensible member and thus to ensure that it is not extended beyond a normal extended position and retracted beyond a normal retracted position.

5. The system of claim 4, wherein the proximity sensors are electromagnetic sensors, optical sensors, or optical sensors sensitive to a range of wavelengths in the visible range, the near-infrared, or both.

6. The system of claim 1, wherein the extensible member is a flat plate.

7. The system of claim 1, wherein at least one of the one or more proximity sensors is located above the container.

8. The system of claim 1, wherein at least one of the one or more proximity sensors is an ultrasonic detector.

9. The system of claim 1, wherein each of the one or more proximity sensors is configured to provide, within its respective sensing cone, independent detection of the distance to the container fill level.

10. The system of claim 1, wherein the system further comprises a drive interface configured to communicate with a second electromechanical assembly configured to regulate article delivery to the chute.

11. The system of claim 10, wherein the drive interface is configured to receive all signals generated by the one or more proximity sensors in a single network.

12. The system of claim 10, wherein the drive interface implements the RS-485 standard or communications standard related thereto.

13. A method of using a chain, a sprocket, a motor, a motor shaft, and an extensible member to varying the length of a variable-length chute, the method comprising:
sending a signal to the motor, the signal causing the motor to rotate accordingly;
rotating the shaft mechanically coupled to the motor;
rotating the sprocket mechanically coupled to the shaft;
moving the chain mechanically coupled to the sprocket; and
moving an extensible member of a chute mechanically coupled to the chain.

14. A method of filling a container with articles from a chute with an attached extensible member configured for extending chute length and involving two sets of one or more proximity sensors, the method comprising:
detecting, with a first set of one or more proximity sensors, a container fill level;
detecting, with a second set of one or more proximity sensors, an extensible member position;
if the fill level is below a first predetermined amount:
if the fill level is below a second predetermined amount and the extensible member is in a retracted position, moving the extensible member to an extended position and allowing transfer of articles to the container;
if the fill level is below a second predetermined amount and the extensible member is in an extended position, maintaining the extensible member in the extended position and allowing transfer of articles to the container;
if the fill level is above a second predetermined amount and the extensible member is in an extended position, moving the extensible member to a retracted position and allowing transfer of articles to the container; and
if the fill level is above a second predetermined amount and the extensible member is in a retracted position, maintaining the extensible member in the retracted position and allowing transfer of articles to the container; and
if the fill level is above a first predetermined amount:
disallowing transfer of articles to the container.

15. The method of claim 14, wherein the first predetermined amount is greater than the second predetermined amount.
